(19) United States
(12) Patent Application Publication
(10) Pub. No.: US 2020/0269998 A1
(43) Pub. Date: Aug. 27, 2020

(54) ROTATING MASS PROPULSION SYSTEM METHOD AND APPARATUS

(71) Applicant: Larry D. Sinclair, Chino Valley, AZ (US)

(72) Inventor: Larry D. Sinclair, Chino Valley, AZ (US)

(21) Appl. No.: 16/286,506

(22) Filed: Feb. 26, 2019

(51) Int. Cl. B64G 1/40; F03G 3/08; B64G 1/10; B64G 1/44; B64G 1/42; B64G 1/24

(52) U.S. Cl. CPC B64G 1/409; F03G 3/08; B64G 1/10; B64G 2001/247; B64G 1/425; B64G 1/24; B64G 1/443

(57) ABSTRACT

The disclosure relates to a method and apparatus of rotating mass propulsion. The method and apparatus entails rotating a mass to generate thrust. Varying the speed and direction of rotation provides some control of the magnitude and direction of the thrust generated. The method and apparatus of the invention pertinent to a propulsion system for spacecrafts or astromotive vehicles under conditions of zero to low gravity and atmosphere.

### FIELD

This invention is generally related to a rotating mass propulsion system and specifically related to a rotating mass propulsion system for low or zero gravity satellites and spacecrafts.

### BACKGROUND

There are approximately 2,300 satellites in orbit around the earth today. Military, scientific, and communication satellites are vital to the functioning of many industrialized nations. While only a few countries have the capabilities to launch their own satellites, companies such as SpaceX and United Launch Alliance have privatized space launches and made it available for purchase. Thanks to the commoditization of space flight, even the smallest of nations can afford to place a satellite in orbit. Countries such as Ghana have launched their own satellite as a mark of national pride and also to cut the cost of buying satellite data from other countries. Consequently, geosynchronous orbit has become quite crowded.

Satellites are a key component of global telecommunication. About 60 percent of all satellites play some role in communication. Communication satellites are generally in geostationary orbit above the earth. Other satellites, such as remote sensing satellite, may need to be repositioned to cover another area of the globe. Satellites such as Global Positioning System (GPS) satellites in lower earth orbit may need to be constantly repositioned due to orbital decay. Some satellites may also need to be moved to avoid collision with other satellites or space debris.

In addition to active satellites, there are many defunct satellites that were never safely decommissioned. Oftentimes, these old satellites are left to continue in their stable orbit instead of moving them to a decaying orbit. These satellites are sometimes used as targets for missile tests resulting in even more space debris. NASA actively tracks more than 500,000 pieces of space debris in orbit around the Earth. Some are naturally occurring such as meteoroids and other are manmade. Some of these pieces of space debris may travel at speed of 17,500 miles per hour. In order to avoid catastrophic collision with space debris, oftentimes the spacecraft may need to be moved out of the path of collision. A reliable, efficient, and economical means of propulsion is thus highly sought after by satellite manufacturers.

Satellites traditionally move by means of propellant thrusters. Monopropellant hydrazine thruster may be used for attitude, trajectory and orbit control of small and mid-size satellites and spacecraft. Thrust is generated when a control valve is commanded to open causing the propellant hydrazine to be fed to the thrust chamber where a decomposition reaction takes place within a catalyst bed. While regarded as dependable and low-cost, propellant thrusters suffer from at least one obvious flaw. Eventually, the propellant runs out. Large fuel tanks are not feasible due to the cost to weight ratio of getting a satellite into orbit. Thus, while dependable, propellant thrusters have a finite amount of fuel and cannot provide thrust over a long period of time especially if multiple maneuvers must be taken frequently.

Currently, the slowest form of propulsion, and the most fuel-efficient, is the ion engine or ion drive. An ion thruster or ion drive is a form of electric propulsion used primarily for spacecraft propulsion. It creates thrust by accelerating positive ions with electricity. An ion thruster ionizes a neutral gas by extracting some electrons out of atoms, creating a cloud of positive ions. Ion thrusters have demonstrated fuel efficiencies of over 90 percent as compared to the 35 percent efficiency of a chemical fuel rocket. Although efficient, ion thrusters still require some fuel in the form of a neutral gas. Additionally, ion thrusters are still relatively cutting-edge technology and thus expensive.

What is needed is a means for satellite locomotion that can replenished in orbit and is relatively inexpensive to produce.

### SUMMARY

An aspect of this invention is generally related to a method and apparatus of a rotating mass propulsion system for use in zero or low gravity satellites and spacecrafts where atmospheric drag is not a relevant factor in propulsion.

Embodiments of the invention comprise one or more of rotating masses that are generally circular or disk shaped. Preferably, more than one rotating mass is used, as using only one rotating mass can twist the spacecraft. Multiple rotating masses can be equally spaced about the circumference of a circle, the circle being on a reference plane, such that the thrust at each rotating mass is balanced by one or more of the other rotating mass on the circumference of the circle. The axis of rotation of the rotating mass would be parallel to the reference plane. It would be beneficial to have the center of rotation of each rotating mass lie on the same plane. Actuation of the rotating mass causes thrust perpendicular to the plane. Varying the speed and direction of the rotation can vary the amount of net thrust as well as cause torque about the center of the circle allowing for limited directional control of the net thrust produced.

This summary was provided to efficiently present the general concept of the invention and should not be interpreted as limiting the scope of the claims.

### BRIEF DESCRIPTION OF THE DRAWINGS

FIG. 1 illustrates a perspective view of a rotating mass propulsion system installed in an exemplary spacecraft.

FIG. 2A illustrates a side view of a single disk of the rotating mass propulsion device.

FIG. 2B is a side view of a single rotating mass and motor of the exemplary rotating mass propulsion device.

FIG. 3A-D are a top down view of exemplary rotating mass propulsion device with n propulsion units.

FIG. 4 is a top down view of an exemplary rotating mass propulsion device.

FIG. 5 is a front view of an exemplary rotating mass propulsion device with secured to an engine mount.

### DETAILED DESCRIPTION OF THE EXEMPLARY EMBODIMENTS

Method and apparatus to provide a rotating mass propulsion system are described below. In the following description, numerous specific details are set forth. However, it is understood that embodiments of the invention may be practiced without these specific details. In other instances, well-known components, structures, and techniques have not been shown in detail in order to not obscure the understanding of this description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

The word spacecraft is used in this Application to denote a vehicle or device designed for travel or operate outside the Earth's atmosphere, whereas a satellite is an object that orbits the Earth, the moon, or another celestial body. The term “astromotive” is used in this Application in conjunction with “device” to refer to a personal device for moving a person or persons in low or zero gravity conditions.

For thousands of years humankind has looked to the stars, but only relatively recently have we been able to reach beyond Earth's gravity. The untapped potential for space exploration and exploitation are enormous, but the cost of researching and developing viable space programs once limited the playing field to a handful of rich and technologically advanced nations.

With the rise of companies such as SpaceX, Virgin Galactic, Blue Origin, Sierra Nevada, etc., space exploration has finally become commercialized and not restricted to only wealthy industrialized countries with their geo-political agendas. Although these innovative companies have opened the playing field, there remain a prohibitive cost associated with sending objects into space. Launch costs are still in the millions of U.S. dollars, thus making satellites and zero-gravity research not quite available to all.

The cost of launching a satellite varies depending on the mass of the satellite, the orbital altitude, and the orbital inclination of the final satellite orbit. The advent of reusable launch systems has dropped the price of a launch in the range of 2,000-30,000 USD per kilogram. As total cost of placing a satellite or spacecraft into orbit is heavily dependent on the mass of the satellite, it is advantageous to reduce the mass of the propulsion system in a satellite or spacecraft being launched. One of method of reducing satellite mass would be to use a propulsion system that does not need a chemical fuel source.

A propulsion system that does not rely on chemical fuels can utilize a linear force generated by a rotating mass. Ideally the rotating mass would be very dense and in the shape of a torus. The rotating mass can be any material composition—solid, liquid, or gas—preferably a liquid. Using a fluid allows for maximum available volume in the torus for the rotating mass. A liquid also has the inherent ability to be self-balancing when rotating.

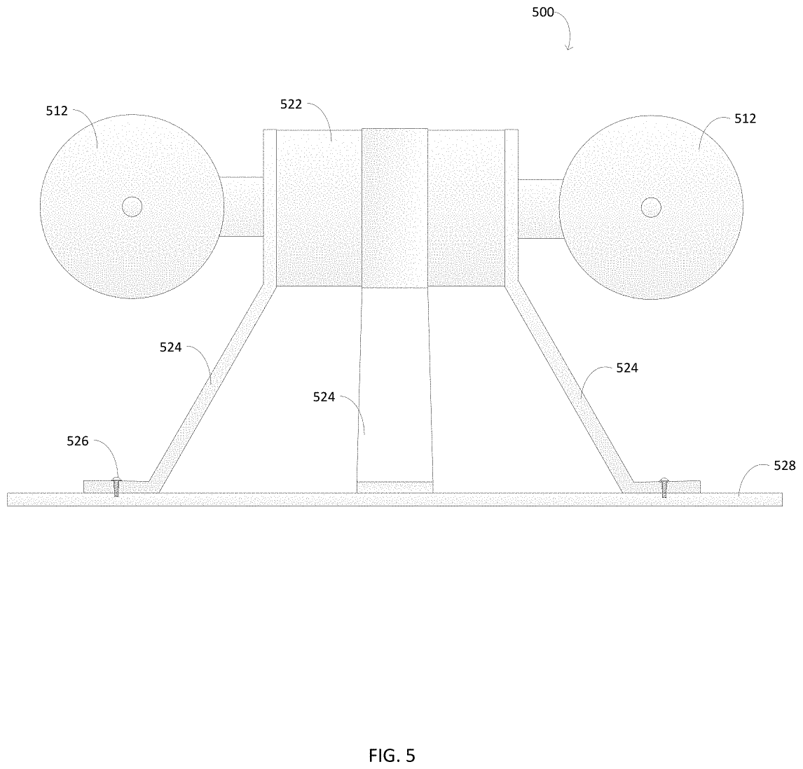

Embodiments of the invention use available components and materials to create a functioning engine utilizing the underlying principles of the invention. For example, in some embodiments, eight discs are used instead of a torus shaped rotating mass. The disks are effectively eight thin “slices” of the entire rotating “torus” mass. The axis of rotation of each disk is parallel to a reference plane. The rotation of the “torus” as a whole would be perpendicular to the reference plane such that the rotating mass is through the center of the “torus”. Referring briefly to FIG. 5, the reference plane would be the horizontal surface 528. In this illustration, the two rotating masses 512 comprise two slices of a “torus”. The axis of rotation of the rotating masses 512 lie parallel to reference plane 528, but the rotation of the torus as a whole is perpendicular to the reference plane 528. Ideally, 360 discs would be more effective but due to engineering constraints, embodiments of the invention have fewer disks and motors. Currently each disc “slice” contributes 0.5% of effect—so having only eight “slices” results in approximately 4% effect. Within engineering constraints, more disks should result in more effective thrust.

Embodiments of the invention use batteries to power a motor which in turn rotate a mass. Rotating masses are preferably placed on the same plane and equally spaced on that plane, e.g. about the circumference of a circle. As weight is of concern, a light weight battery would be preferred. A rechargeable battery connected to a solar array would also be capable of extending the life of the battery and thus the productive life of the satellite. Using a battery as the power source for satellite propulsion is preferred because it saves on the cost of translating a fuel source into orbit. Furthermore, a battery is a renewable source of energy that can extend the useful life of the propulsion system and satellite. Batteries can be recharged with solar energy, thus avoiding the need for liquid or solid refueling.

The force produced by the rotating mass is very slight, in the order of 10 gram of force (thrust) per 4 amps of electricity. Within the earth's atmosphere, thrust produced by a rotating mass propulsion system would not be a feasible means of propelling a craft. However, in space, without air resistance or gravity, even a small force would be sufficient to slowly propel a spacecraft.

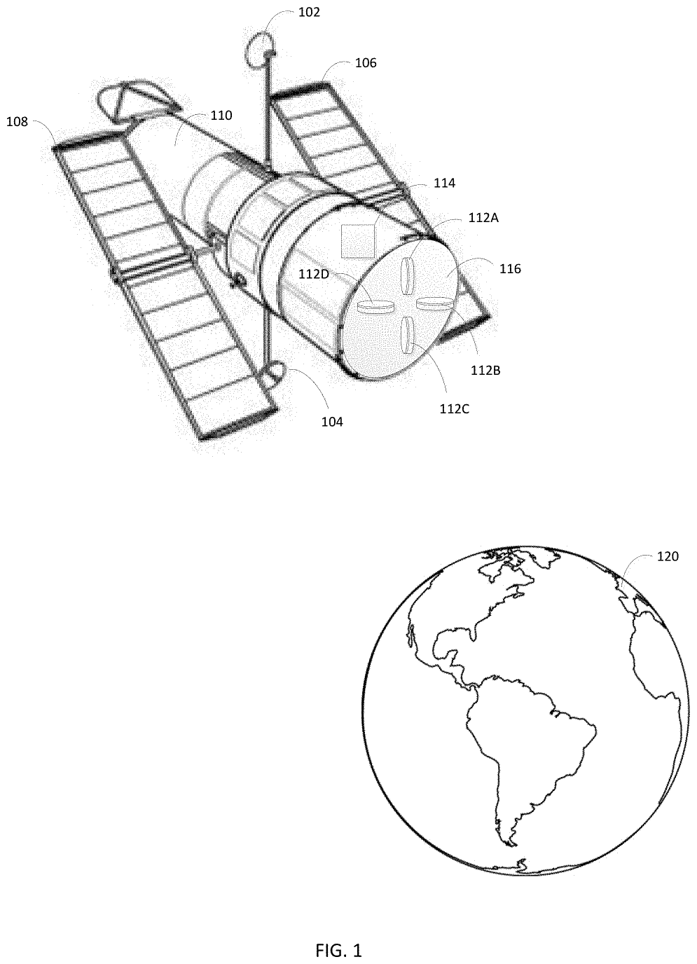

An exemplary embodiment of the invention is illustrated in FIG. 1 of this application. In FIG. 1, a rotating mass propulsion system is installed aboard an exemplary spacecraft. The spacecraft in FIG. 1 is a satellite 100 in orbit above the Earth 120. The satellite 100 is far enough away from the Earth, such that air resistance and gravity is not a factor limiting propulsion. A satellite in low earth orbit can experience orbital decay without periodic boosts to maintain station. It may be possible for satellite 100 to use a rotating mass propulsion system to provide enough boost to maintain station. A satellite 100 in high earth orbit would encounter less atmospheric drag and may not need to use thrust to maintain a geosynchronous orbit. However, a satellite 100 in high earth orbit may still need to maneuver, for example: to avoid space debris or to cover a different geo location in the cases of remote sensing satellites.

In FIG. 1, the rotating mass propulsion system is shown installed at the aft end of the satellite 100. The front end 110 of the satellite 100 can house various communication arrays and processors dependent on the main mission criteria of the spacecraft 100. Antennas 102/104 can receive and transmit data from ground-based installations or other satellites. Data such as communication, sensor readings, satellite status, etc., can be passed through antennas 102/104. Instructions to satellite 100 can also be received by antennas 102/104. Such instruction can be used for maintaining geosynchronous orbit or for directing collision avoidance. For example, instructions to spin up one or more rotating masses 112A-D can be sent to the satellite 100 through antennas 102/104. Spinning up one rotating mass would twist the spacecraft. For linear motion, at least two opposing rotating masses would need to be activated. Spinning three rotating masses, and varying their rate of spin, would allow for steering.

As illustrated in one embodiment of the invention, the rotating mass propulsion system comprises four rotating masses 112A-D. Rotating masses 112A-D can be disk shaped. The discs could be tapered, e.g. thin in the center and thicker at the circumference, perhaps even tube shaped at the circumference. Tapering the disk from center to circumference provides more mass efficient percentage effect.

Rotating masses 112A-D are located on the same circular plane, in this case at the aft end 116 of the satellite 100. Ideally, the rotating masses should be oriented in the same direction. For example, in FIG. 1 rotating masses 112A-D are oriented perpendicular to the plane of the aft end of satellite 100. Thus, thrust generated by each rotating mass 112A-D are also perpendicular to the plane of the aft end of the satellite 100. Although, the rotating mass propulsion system is shown uncovered on the aft end of satellite 100 in this embodiment, a dome or other protective covering may surround the rotating mass 112 without affecting their function. In fact, it should be made clear that the rotating masses 112A-D may be mounted in other areas of the satellite 100 and still function. The rotating mass propulsion system does not expel gasses as with traditional rocket technology, thus is preferably mounted inside the satellite 100 for example. Being mounted inside satellite 100 would allow a crew (on crewed spacecrafts) to perform maintenance on the rotating mass propulsion system. Mounting the rotating mass propulsion system inside the skin of the ship can also protect it from micro meteorites and other space debris.

Each rotating mass 112A-D, provides a vectored force. By placing each rotating mass 112A-D in a planar circle equidistant from each other around the circumference of said circle, the vectored force of each rotating mass 112A-D are balanced to provide thrust in one direction with minimal torque to the satellite 100. In embodiments of the invention with multiple rotating masses or discs, pairs of disks should rotate in opposition. The disks should be substantially aligned 180 degrees, with no tilt, to eliminate a “torque twisting” effect applied to the engine frame.

Rotating masses 112A-D can be rotated by one or more motors. The motors that spin the rotating mass 112A-D are not illustrated in FIG. 1; being inside the skin of the satellite 100.

Electric motors can be utilized to spin the rotating masses. An electric motor is preferred over combustion engines due to the lack of oxygen in the vacuum of space among other reasons. Combustion engines would also require fuel that is not easily or economically replaceable. In the simplest configuration, one electric motor is coupled to one rotating mass. A one-to-one ratio of electric motor to rotating mass allows for variable independent rotation of each rotating mass for directional control. When all of the rotating masses 112A-D are spun in the same direction and the same rate of spin, the thrust is substantially in the same direction. Varying the spin rate of one rotating mass 112A-D can cause the thrust to become unbalanced. Increasing the spin rate of rotating mass 112C for example can cause the satellite to steer upwards. “Upwards” of course being a relative term, for the purpose of this application “upwards” is towards the top of the page in FIG. 1. Although a one-to-one ratio is preferred, more than one electric motor can be paired with a rotating mass for greater speed of rotation and increased thrust. More than one rotating mass can also be paired with each electric motor.

The embodiment of the invention, described above and illustrated in FIG. 1 is scaled to propel a large satellite. The invention, however, is not limited only to propelling large spacecrafts. The invention is scalable. The rotating mass propulsion system can be scaled to whatever size is needed to efficiently propel the spacecraft or vehicle it is attached to. For example, miniaturized embodiments of the invention can be applicable to providing propulsion for CubeSats. While multiple larger rotating mass propulsion systems can be used to propel entire space stations.

The force generated by each rotating mass 112 can be generally expressed by the following equations.

$$\begin{matrix}F = - G \frac{{m}_{1} {m}_{2}}{{r}^{2}} & ( i ) \\ I = \int {r}^{2} d m \\ Total mass M \to σ = \frac{M}{area} = \frac{M}{π {R}^{2}} [ \frac{kg}{area} ] \\ 2 π dr σ = differential mass = d m & ( ii ) \\ I = \int {r}^{2} 2 π r d r σ = σ 2 π {\int }_{0}^{R} {r}^{3} d r & ( iii ) \\ I = 2 π σ \frac{{R}^{4}}{4} = 2 π \frac{M}{π {r}^{2}} \frac{{Rr}^{4}}{4} & ( iv ) \\ I = \frac{M}{2} {R}^{2} moment of inertia of disk & ( v ) \\ I = \int {r}^{2} d m = {R}^{2} \int d m = {R}^{2} M & ( vi ) \\ d m = \frac{dM}{dr} & ( vii ) \\ {E}_{total} = {E}_{trans} + {E}_{rot} = \frac{1}{2} {mv}^{2} + \frac{1}{2} {Iw}^{2} & ( viii ) \\ ɛ = \frac{{T}_{trans}}{{T}_{rot}} so {T}_{trans} = ɛ {T}_{rot} & ( ix ) \\ N = \frac{d L}{dT} = Iw = I \frac{d W}{dt} [ kg \cdot {m}^{2} \frac{1}{{s}^{2}} ] & ( x ) \\ F = ma & ( xi ) \\ F = ma = m \frac{dv}{dt} = m \frac{dv}{dx} \frac{dx}{dt} = mv \frac{dv}{dt} = m \frac{{dv}^{2}}{2 dx} & ( xii ) \\ F = \frac{d}{dx} ( \frac{1}{2} {mv}^{2} ) = \frac{d}{dx} {T}_{trans} = \frac{d}{dx} ɛ {T}_{rot} = E \frac{d}{dx} ( \frac{1}{2} {Iw}^{2} ) & ( xiii ) \\ F = \frac{d}{dx} ( ɛ {E}_{rot} ) = ɛ \frac{d}{dx} ( \frac{1}{2} {Iw}^{2} ) = ɛ \frac{d}{dx} ( \frac{1}{2} \frac{1}{2} {MR}^{2} {w}^{2} ) & ( xiv ) \\ F = \frac{ɛ {MR}^{2}}{4} \frac{d}{dx} {w}^{2} & ( xv ) \\ W = \int F \cdot dx & ( xvi ) \\ co [ \frac{rad}{s} ] = \frac{2 π}{T} [ \frac{1}{2} ] = \frac{2 π \cdot 60}{{T}_{rpm}} & ( xvii ) \\ {N}_{rpm} [ \frac{2 π}{min} ] = \frac{{N}_{rpm}}{60} [ \frac{2 π}{s} ] = \frac{{N}_{rpm}}{60} 2 π [ \frac{rad}{s} ] & ( xviii ) \\ W = \frac{2 π}{60} {N}_{rpm} & ( xix ) \\ F = μ {F}_{n} = μ {M}_{disk} g & ( xx )\end{matrix}$$

The motors spinning rotating masses 112A-D can be powered by a battery 114 which in turn is recharged by solar panels 106 and 108. Electric motors are preferred because they do not need to combust solid or liquid fuel. Electric motors, however, need a source of electricity to provide power to the motors. Battery 114 can provide a source of electricity that is rechargeable for thousands of recharge cycles, thus potentially extending the life of the satellite to dozens of years of use. Battery 114 can be of any type e.g. nickel cadmium, nickel metal hydride, lithium ion, etc. with preference to lighter more efficient batteries with more recharge cycles and greater energy density. In order to continuously provide electricity to the electric motors, battery 114 can be coupled to one or more solar collectors 106 and 108 that are preferably moveable to maximize solar energy collection.

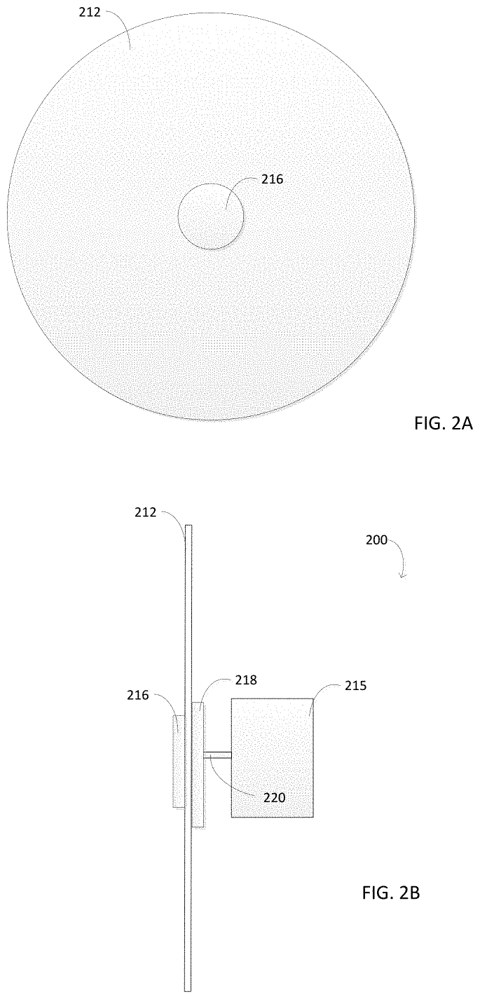

The rotating mass 212 is illustrated in more detail in FIG. 2A and FIG. 2B. A frontal view of an exemplary rotating mass 212 is shown in FIG. 2A. The illustrated rotating mass 212 can be a disk with a center restraint 216 located substantially at the center of rotation of the disk. Center restraint 216 holds the disk in place as it rotates at high velocity about the center of rotation. A variety of methods of holding the rotating mass 212 is contemplated within the scope of the invention and should be known to a person of ordinary skill in the art.

In FIG. 2B a basic rotating mass unit 200 is shown. As illustrated in FIG. 2B, the rotating mass 212 is sandwiched between center restraint 216 and backplate 218. To securely hold rotating mass 212 between center restraint 216 and backplate 218, a screw can be threaded through the middle of center restraint 216, rotating mass 212 and backplate 218, fastening all three structures together so that they rotate as one. A shaft 220 can be affixed to backplate 218. Motor 215 rotates the shaft 220 which in turn rotates the rotating mass 212.

In FIG. 2B the rotating mass 212 are illustrated as rigid disks of uniform shape and density. As previously mentioned, the disks may be tapered such that the center is thinner and the outer circumference thicker allowing more mass to be concentrated at the outer portion of the spinning disks. The shaft 218 should be attached to rotating mass 212 at the center of rotation of the rotating mass 212 to reduce wobble. Other means of affixing rotating mass 212 to shaft 218, such as welds, locknuts, friction fit, etc., should be considered within the scope of the invention.

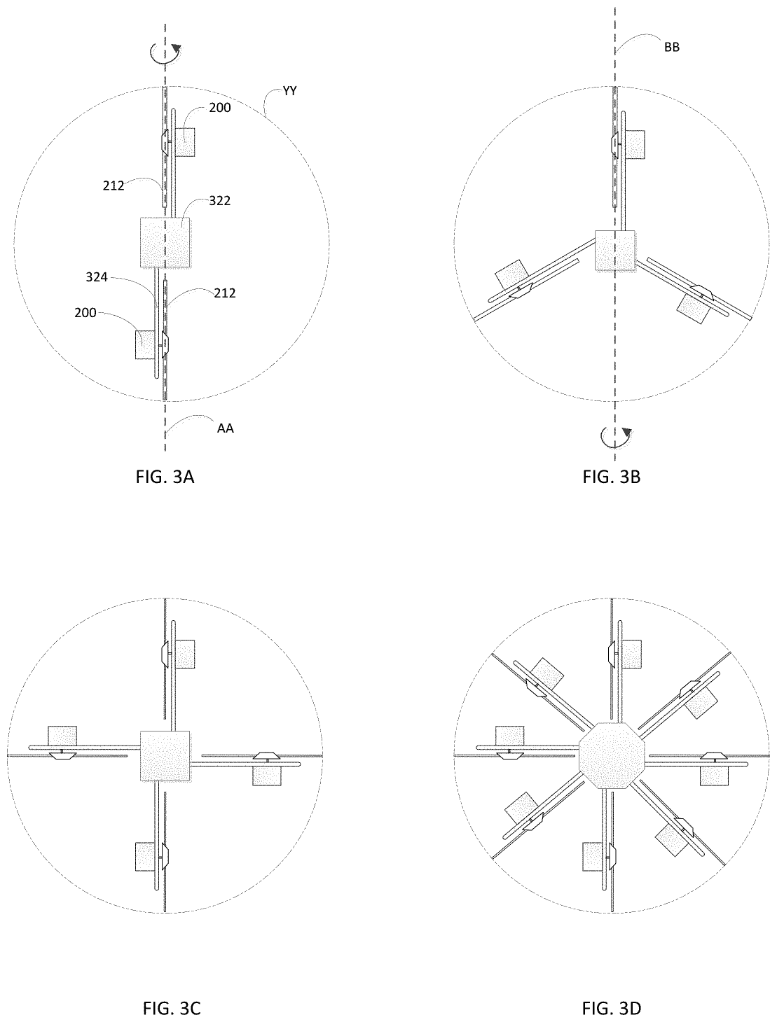

FIGS. 3A-D illustrate various positioning possibilities rotating mass propulsion unit in different embodiments of the invention. In FIG. 3A two rotating mass propulsion units 200, like those described in FIG. 2B are positioned opposite each other, substantially 180 degrees apart. Each mass propulsion unit 200 is attached to a mounting frame 322 by a mounting arm 324. The rotating mass 212 of each rotating mass propulsion unit 200 are orientated in the same direction, perpendicular to the plane of paper. Ideally, the center of rotation of each rotating mass should be on the same plane; said plane represented by the virtual circle YY in FIG. 3A. To reduce twisting, opposite mass propulsion unit 200 are mounted such that their rotating masses 212 are along the same axis AA through the center of a mounting frame 322 and circle YY. Likewise, the edge of each rotating mass 212 lie on the circumference of circle YY, thereby the distance of each rotating mass 212 from the center of circle YY is substantially the same and the moment of each rotating mass 212 should be substantially the same.

FIG. 3B illustrates 3 rotating mass propulsion units on the same plane approximately 120 degrees apart. FIG. 3C illustrates 4 rotating mass propulsion units on the same plane approximately 90 degrees apart. FIG. 3D illustrates 8 rotating mass propulsion units on the same plane approximately 45 degrees apart. It should be apparent from the illustrations that numerous positions and quantities of rotating mass propulsion units are possible. Placing the rotating mass propulsion units at equidistant points balances out the thrust of the rotating mass propulsion system and mitigates torque “twist” about the plane of the circle.

Although the rotating mass propulsion units of FIG. 3A-D are illustrated positioned much like spokes on a wheel, other positions can also be viable. For example, the rotating masses can be placed along the sides of a square. In embodiments of the invention with multiple rotating mass units it is preferable that the rotating masses are equally spaced apart, such that the thrust at each rotating mass is balanced by one or more of the other rotating masses. Furthermore, the center of rotation of each rotating mass should be on the same plane to reduce undesired twist.

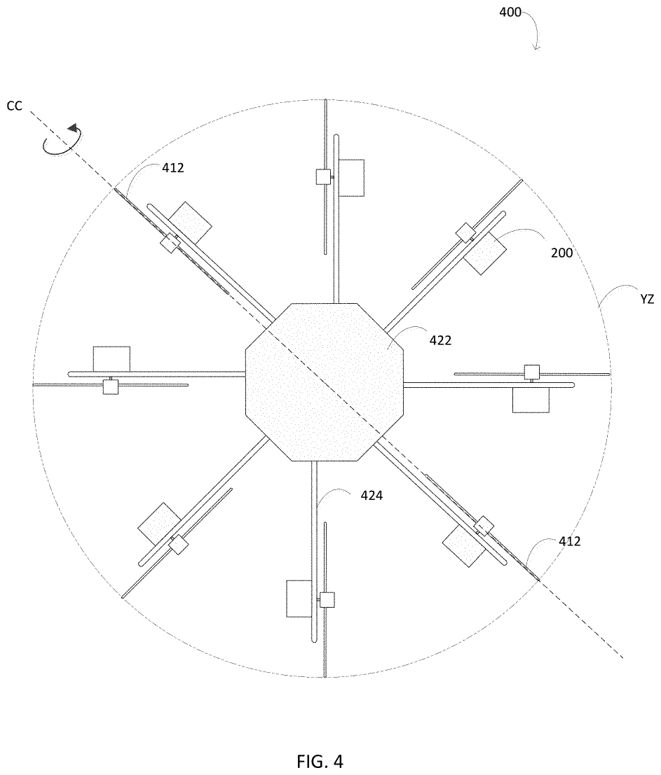

Referring now to FIG. 4; a top down view of an embodiment of the invention with eight rotating mass propulsion units 200, each placed at a side of an octagonal frame 422. As with the previously described embodiments of the invention, each rotating mass propulsion unit 200 is placed an equidistance apart to balance out the thrust provided by the rotation of each rotating mass 412. Mounting arms 424 and motors are offset so that the discs are exactly in the centerline of the circle and opposite 180 degrees. For example, in FIG. 4, two of the rotating masses 412 are positioned along an axis CC such that they are 180 degrees opposite each other. Axis CC runs through the center of the octagonal frame 422 as well as the center of virtual circle YZ.

Certain specifications are hereby provided for the components described in FIG. 4, however, the scope of the invention is not be limited to only the specifications of these components. For example, different motors with different specifications can be used without deviating from the principles of the invention hereby described in the exemplary embodiment in FIG. 4.

In the embodiment of the invention illustrated in FIG. 4, Eight 3-phase brushless 2300 KV (which stands for 2300 RPM per volt) motors are used to rotate plastic disks. The disks have a mass of 14 grams each with two disks mounted on each motor for a total of 224 grams of rotating mass 412. The eight motors are controlled through a 20 amp “ESC” (Electronic speed control) controller. An electronic speed control or ESC is an electronic circuit that controls and regulates the speed of an electric motor. An ECS can also reverse the direction of the motor and provide dynamic braking or regenerative braking. A regenerative braking system can be employed to recover some energy to the battery by converting the kinetic energy of the rotating mass 412 back into stored potential energy in the battery. The ESC sends pulsed DC current to each motor with faster pulses providing faster motor speed. For the ESC used in embodiment of FIG. 4, the max pulse rate is 35,000 RPM on a 12-pole motor.

Each motor has a separate ESC to provide independent rotation speed control to each motor, thus providing variable thrust and a limited form of vector propulsion control. Control commands from a flight controller to the ESC's can be wired in parallel for thrust only. In embodiments of the invention, the ESC's are wired to a flight controller that determines speed for each motor by interpolation in order to steer the engine on a controlled flight vector.

In the embodiment illustrated in FIG. 4, 224 grams of rotating mass, rotating at˜5K RPM generates˜10 grams of continuous force or thrust. 10 grams of force produced from 224 grams of rotating mass at˜5K RPM=0.044 effect=4.4% thrust. Thrust increases with the speed of the disks so higher RPM would result in more thrust. However, higher RPM also results in higher current draws. It was found that at 0 RPM (idle) there was a current draw of 0.54 amps. At 3549 RPM the current draw was 1.67 amps. 4427 RPM=2.42 amps and 5828 RPM=4.25 amps.

An engine mount 500 may be used to secure the rotating mass propulsion system 400 of FIG. 4 to a spacecraft. An example of said engine mount 500 is illustrated in FIG. 5. An engine mount 500 with mounting legs 524 is shown in a frontal view illustration in FIG. 5. Each leg 524 of the engine mount 500 can be attached to a side of the octagonal frame 522 of the rotating mass system 400 of FIG. 4D. Only two of the 8 rotating masses 512 are shown in FIG. 5 to prevent a confusing clutter that may hide more important details of the engine mount 500.

Engine mount 500 can be mounted to the frame 528 of the spacecraft at each horizontal mounting point at the lower portion of the legs 524. A screw 526 or other method, e.g. welding, rivet, etc., of affixing the leg 524 to the frame 528 of a spacecraft can be used. Engine mount 500 can be formed of a light weight rigid material such as aluminum, stainless steel, or plastic. A factor in selecting the material of the engine mount 500 is of course the tensile strength needed to withstand the thrust generated by the rotating mass propulsion system. Engine mount material must be able to withstand the dynamic force exerted by the engine during operation as well as the mass of the engine unit. Engine mount 500 can also be mounted to any strong horizontal surface inside the skin of the spacecraft. It can be desirable to make engine mount 500 easily mountable and removeable to make each rotating mass propulsion unit modular. Astronauts, with limited tools, can remove, replace, or add modular rotating mass propulsion unit as needed during spacewalks.

Currently astronauts have no means of propulsion during spacewalks. Astronauts working outside the international space station wear a jet backpack known as SAFER. SAFER is equipped with very small thrusters that expel gas and propel an astronaut in the direction he or she wants to go. However, the SAFER system is for emergency only, in case the astronaut becomes untethered from the Space Station. The SAFER system is an emergency system and is not meant as an “astromotive” device.

### Astromotive Device

Embodiments of the invention as previously described above have been primarily concerned with industrial applications for the invention. Satellites and other spacecrafts used by governments and industries could benefit greatly by using this invention. The invention, however is not limited to only industrial applications and is equally, if not more so, beneficial to personal and recreational use.

An astromotive device, i.e. a personal device for moving a person or persons in low or zero gravity conditions can have a massive impact on future non-industrial applications. The invention may be adapted for use in personal and recreational astromotive vehicles that would directly benefit humankind.

### Conclusion

Although certain exemplary embodiments and methods have been described in some detail, for clarity of understanding and by way of example, it will be apparent from the foregoing disclosure to those skilled in the art that variations, modifications, changes, and adaptations of such embodiments and methods may be made without departing from the true spirit and scope of the invention. This disclosure contemplates other embodiments or purposes.

For example, it will be appreciated that one of ordinary skill in the art will be able to employ a number of corresponding alternative and equivalent structural details, such as equivalent ways of fastening, mounting, coupling, or engaging tool components, equivalent mechanisms for producing particular actuation motions, and equivalent mechanisms for delivering electrical energy. As another example, structural details from one embodiment may be combined with or utilized in other disclosed embodiments. Therefore, the above description should not be taken as limiting the scope of the invention which is defined by the appended claims.

What is claimed is:

1. A rotating mass propulsion system for a spacecraft comprising;
an engine mount to attach to a frame of the spacecraft;
a rotating mass propulsion unit coupled to the engine mount the rotating mass propulsion unit further comprising;
an electric motor to rotate a shaft;
a battery to drive the electric motor;
a control unit to control the speed of rotation of the shaft;
a rotating mass attached to the shaft;
a solar collector to provide power to the battery.

2. The rotating mass propulsion system of claim 1, wherein the rotating mass is a disk.

3. The rotating mass propulsion system of claim 2, wherein the disk is thicker at the disk's circumference and thinner at the disk's center.

4. The rotating mass propulsion system of claim 1, wherein the battery is a rechargeable battery.

5. The rotating mass propulsion system of claim 1, wherein the control unit is an electronic speed control unit configured to pulse direct current to the electric motor.

6. The rotating mass propulsion system of claim 5, wherein the electronic speed control unit is coupled to and electronically controlled by a flight controller configured to receive steering inputs and translate the steering inputs into speed control outputs at the electronic speed controller

7. The rotating mass propulsion system of claim 1, wherein spacecraft is configured to operate in low and zero gravity non-atmospheric conditions.

8. A rotating mass propulsion unit of a rotating mass propulsion system comprising;
an electric motor configured to receive Direct Current (DC) pulses and rotate a shaft at a speed dependent upon a frequency of the pulses;
a rechargeable battery electrically coupled to the electric motor, the rechargeable battery configured to drive the electric motor;
an electronic speed controller coupled to the electric motor, the electronic speed controller configured to control the speed of rotation of the shaft by varying the frequency of the DC pulses received by the electric motor; and
a rotating mass attached to the shaft;

9. The rotating mass propulsion unit of claim 8, wherein the rotating mass is a disk.

10. The rotating mass propulsion system of claim 9, wherein the disk is thicker at the disk's circumference and thinner at the disk's center.

11. The rotating mass propulsion system of claim 8, wherein the electronic speed control unit is coupled to and electronically controlled by a flight controller configured to receive steering inputs and translate the steering inputs into speed control outputs at the electronic speed controller.

12-15. (canceled)

16. A steerable rotating mass propulsion system for spacecrafts in zero gravity conditions, the steerable rotating mass propulsion system comprising;
a plurality of rotating mass propulsion units coupled to engine mounts, the rotating mass propulsion units arranged at equidistant points around a circle on a plane;
each of the rotating mass propulsion units further comprising;
an electric motor to rotate a shaft;
a rotating mass attached to the shaft;
one or more batteries electrically coupled to the electric motor to provide power to the electric motor; and
a speed control unit to control speed of rotation of the shaft;
a solar collector array to provide power to the one or more batteries; and
a master steering control unit, configured to receive steering inputs and translate the steering inputs into speed control outputs at the speed controller to vary the speed of rotation of one or more of the rotating masses;
wherein the rotating masses of the plurality of rotating mass propulsion units rotate in the same direction relative to their respective electric motor.

17. The steerable rotating mass propulsion system of claim 16, wherein the rotating mass is a disk, the disk being thicker at the disk's circumference and thinner at the disk's center.

18. The steerable rotating mass propulsion system of claim 16, wherein the battery is a rechargeable battery.

19. The steerable rotating mass propulsion system of claim 16, wherein the control unit is an electronic speed control unit configured to pulse direct current to the electric motor.

20. The steerable rotating mass propulsion system of claim 19, wherein the electronic speed control unit is coupled to an electronically controlled by a flight controller configured to receive steering inputs and translate the steering inputs into speed control outputs at the electronic speed controller.

21. The steerable rotating mass propulsion system of claim 16, wherein master steering control unit is further configured to change a heading of the spacecraft by increasing or decreasing the speed of rotation of one or more of the rotating masses of the plurality of rotating mass propulsion units.
